(19) United States
(12) Patent Application Publication
(10) Pub. No.: US 2025/0240856 A1
(43) Pub. Date: Jul. 24, 2025

(54) DRIVE CIRCUIT FOR A LIGHT-EMITTING DIODE LIGHT SOURCE

(71) Applicant: Lutron Technology Company LLC, Coopersburg, PA (US)

(72) Inventor: Stuart W. DeJonge, Riegelsville, PA (US)

(73) Assignee: Lutron Technology Company LLC, Coopersburg, PA (US)

(21) Appl. No.: 19/171,470

(22) Filed: Apr. 7, 2025

Related U.S. Application Data
(63) Continuation of application No. 18/532,112, filed on Dec. 7, 2023, now Pat. No. 12,273,976.
Application No. 18/532,112 is a continuation of application No. 17/833,479, filed on Jun. 6, 2022, now Pat. No. 11,877,361.
Application No. 17/833,479 is a continuation-in-part of application No. 17/162,891, filed on Jan. 29, 2021, now Pat. No. 11,357,084.
(60) Provisional application No. 62/968,566, filed on Jan. 31, 2020.

(51) Int. Cl. H05B 45/385; H05B 45/14; H05B 45/46

(52) U.S. Cl. CPC H05B 45/385; H05B 45/14; H05B 45/46

(57) ABSTRACT

A controllable lighting device may comprise a drive circuit characterized by one or more cycles and a control circuit configured to control the drive circuit to conduct a load current through a light source of the lighting device. The control circuit may be configured to determine one or more operating parameters of the lighting device during a present cycle of the drive circuit based on a feedback signal indicative of a peak magnitude of the load current conducted through the light source. The control circuit may be able to adjust an average magnitude of the load current conducted through the light source so as to adjust an intensity of the light source towards a target intensity based on the operating parameters.

### CROSS-REFERENCE TO RELATED APPLICATION

This application is a continuation of U.S. application Ser. No. 18/532,112 filed Dec. 7, 2023; which is a continuation of U.S. application Ser. No. 17/833,479 filed Jun. 6, 2022, now U.S. Pat. No. 11,877,361 issued Jan. 16, 2024; which is a continuation of U.S. application Ser. No. 17/162,891 filed Jan. 29, 2021, now U.S. Pat. No. 11,357,084 issued Jun. 7, 2022, which claims the benefit of Provisional U.S. Patent Application No. 62/968,566, filed Jan. 31, 2020, the disclosures of which are incorporated herein by reference in their entirety.

### BACKGROUND

Light-emitting diode (LED) light sources (e.g., LED light engines) are replacing conventional incandescent, fluorescent, and halogen lamps as a primary form of lighting devices. LED light sources may comprise a plurality of light-emitting diodes mounted on a single structure and provided in a suitable housing. LED light sources may be more efficient and provide longer operational lives as compared to incandescent, fluorescent, and halogen lamps. An LED driver control device (e.g., an LED driver) may be coupled between a power source, such as an alternating-current (AC) power source or a direct-current (DC) power source, and an LED light source for regulating the power supplied to the LED light source. For example, the LED driver may regulate the voltage provided to the LED light source, the current supplied to the LED light source, or both the current and voltage.

Different control techniques may be employed to drive LED light sources including, for example, a current load control technique and a voltage load control technique. An LED light source driven by the current load control technique may be characterized by a rated current (e.g., approximately 350 milliamps) to which the magnitude (e.g., peak or average magnitude) of the current through the LED light source may be regulated to ensure that the LED light source is illuminated to the appropriate intensity and/or color. An LED light source driven by the voltage load control technique may be characterized by a rated voltage (e.g., approximately 15 volts) to which the voltage across the LED light source may be regulated to ensure proper operation of the LED light source. If an LED light source rated for the voltage load control technique includes multiple parallel strings of LEDs, a current balance regulation element may be used to ensure that the parallel strings have the same impedance so that the same current is drawn in each of the parallel strings.

The light output of an LED light source may be dimmed. Methods for dimming an LED light source may include, for example, a pulse-width modulation (PWM) technique and a constant current reduction (CCR) technique. In pulse-width modulation dimming, a pulsed signal with a varying duty cycle may be supplied to the LED light source. For example, if the LED light source is being controlled using a current load control technique, the peak current supplied to the LED light source may be kept constant during an on-time of the duty cycle of the pulsed signal. The duty cycle of the pulsed signal may be varied, however, to vary the average current supplied to the LED light source, thereby changing the intensity of the light output of the LED light source. As another example, if the LED light source is being controlled using a voltage load control technique, the voltage supplied to the LED light source may be kept constant during the on-time of the duty cycle of the pulsed signal. The duty cycle of the load voltage may be varied, however, to adjust the intensity of the light output. Constant current reduction dimming may be used if an LED light source is being controlled using the current load control technique. In constant current reduction dimming, current may be continuously provided to the LED light source. The DC magnitude of the current provided to the LED light source, however, may be varied to adjust the intensity of the light output.

Examples of LED drivers are described in U.S. Pat. No. 8,492,987, issued Jul. 23, 2013, entitled LOAD CONTROL DEVICE FOR A LIGHT-EMITTING DIODE LIGHT SOURCE; U.S. Pat. No. 9,655,177, issued May 16, 2017, entitled FORWARD CONVERTER HAVING A PRIMARY-SIDE CURRENT SENSE CIRCUIT; and U.S. Pat. No. 9,247,608, issued Jan. 26, 2016, entitled LOAD CONTROL DEVICE FOR A LIGHT-EMITTING DIODE LIGHT SOURCE; the entire disclosures of which are hereby incorporated by reference.

### SUMMARY

As described herein is a controllable lighting device comprising a light-emitting diode (LED) light source, an LED drive circuit, a feedback circuit and a control circuit. The LED drive circuit may include a controllably conductive device configured to conduct a load current through the LED light source and the feedback circuit may be configured to generate a feedback signal indicative of a peak magnitude of the load current conducted through the LED light source. The control circuit may operate to render the controllably conductive device of the LED drive circuit conductive and non-conductive to adjust an average magnitude of the load current conducted through the LED light source so as to adjust an intensity of the LED light source towards a target intensity. For example, the control circuit may render the controllably conductive device conductive for an on-time during a present cycle of the LED drive circuit to cause the controllably conductive device to conduct the load current at the peak magnitude during the on-time. The control circuit may receive the feedback signal during the on-time of the present cycle of the LED drive circuit and determine an operating period for the present cycle based on a magnitude of the feedback signal and the target intensity.

The controllable lighting device may further include a power converter circuit configured to generate a bus voltage that is received by the LED drive circuit. The peak magnitude of the load current during the on-time of the present cycle of the LED drive circuit may be dependent upon the magnitude of the bus voltage, and the control circuit may be coupled to the power converter circuit and configured to generate a bus control signal for adjusting the magnitude of the bus voltage to maintain the respective operating periods of one or more cycles of the LED drive circuit to be between a maximum value and a minimum value. For example, the control circuit may control the bus control signal to decrease the bus voltage in response to determining the that the operating period of the present cycle of the LED drive circuit is above the maximum value and to increase the bus voltage in response to determining that the operating period of the present cycle of the LED drive circuit is below the minimum value. The maximum value of the operating period may be set to a first value when the target intensity is between a maximum intensity and a transition intensity, and may be increased from the first value when the target intensity is below the transition intensity. The minimum value of the operating period may be set to a value independent of the target intensity of the LED light source.

### BRIEF DESCRIPTION OF THE DRAWINGS

FIG. 1 is a simplified block diagram of a controllable electrical device, such as a controllable light source.

FIGS. 2A and 2B are simplified schematic diagrams of example drive circuits, such as light-emitting diode (LED) drive circuits, of a controllable light source.

FIG. 3 shows example plots of the relationships between various operating parameters and a target intensity of the controllable light source of FIG. 2.

FIG. 4 shows example waveforms of a load current illustrating the operation of a controllable lighting device at various target intensities.

FIG. 5 is a simplified flow diagram of an example control procedure for controlling a controllable light source.

FIGS. 6A-6C show example waveforms illustrating the operation of a during the controllable lighting device during execution of the control procedure of FIG. 5.

### DETAILED DESCRIPTION

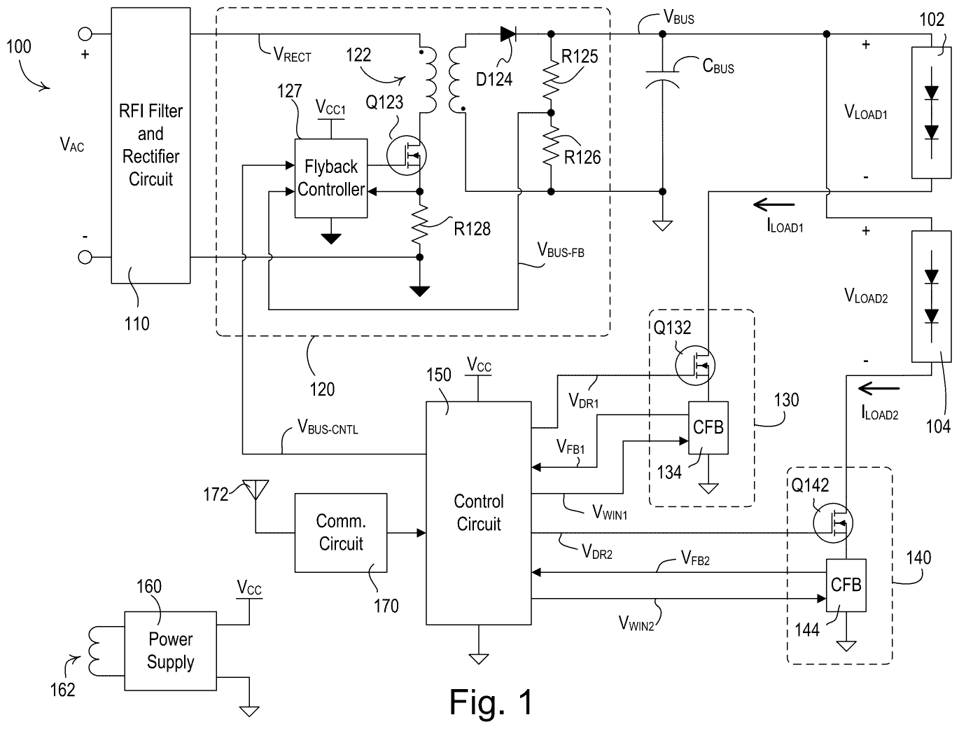

FIG. 1 is a simplified block diagram of a controllable electrical device, such as a controllable lighting device 100 (e.g., a controllable light source). For example, the controllable lighting device 100 may be a lamp that comprise one or more light sources, such as light-emitting diode (LED) light sources 102, 104 (e.g., LED light engines). The LED light sources 102, 104 may be controlled to adjust an intensity and/or a color (e.g., a color temperature) of a cumulative light output of the controllable lighting device 100. Each LED light source 102, 104 is shown in FIG. 1 as a plurality of LEDs connected in series but may comprise a single LED or a plurality of LEDs connected in parallel or a suitable combination thereof, depending on the particular lighting system. In addition, each LED light source 102, 104 may comprise one or more organic light-emitting diodes (OLEDs). The controllable lighting device 100 may include a plurality of different LED light sources, which may be rated at different magnitudes of load current and voltage. While not shown in FIG. 1, the controllable lighting device 100 may comprise a housing (e.g., a translucent housing) in which the LED light sources are located and through which the LED light sources may shine. For example, the controllable lighting device 100 may be capable of providing warm-dimming such that the color temperature of the cumulative light output shifts towards a warm-white color temperature as the intensity of the cumulative light output is decreased. For example, the first LED light source 102 may comprise a white LED light source and the second LED light source 104 may comprise a warm-white (e.g., red) LED light source, and the first LED light source 102 may have a higher power rating than the second LED light source 104.

The controllable lighting device 100 may be a screw-in LED lamp configured to be screwed into a standard Edison socket. The controllable light device 100 may comprise a screw-in base that includes a hot connection H and a neutral connection N for receiving an alternating-current (AC) voltage V_{AC} from an AC power source (not shown). The hot connection H and the neutral connection N may also be configured to receive a direct-current (DC) voltage from a DC power source. The controllable lighting device 100 may comprise a radio-frequency interference (RFI) filter and rectifier circuit 110, which may receive the AC voltage V_{AC}. The RFI filter and rectifier circuit 110 may operate to minimize the noise provided on the AC power source and to generate a rectified voltage V_{RECT}.

The controllable lighting device 100 may comprise a power converter circuit 120, such as a flyback converter, which may receive the rectified voltage V_{RECT} and generate a variable direct-current (DC) bus voltage V_{BUS} across a bus capacitor C_{BUS}. The power converter circuit 120 may comprise other types of power converter circuits, such as, for example, a boost converter, a buck converter, a buck-boost converter, a single-ended primary-inductance converter (SEPIC), a Ćuk converter, or any other suitable power converter circuit for generating an appropriate bus voltage. The power converter circuit 120 may provide electrical isolation between the AC power source and the LED light source 102, 104 and may operate as a power factor correction (PFC) circuit to adjust the power factor of the controllable lighting device 100 towards a power factor of one.

As shown in FIG. 1, the flyback converter 120 may comprise a flyback transformer 122, a field-effect transistor (FET) Q123, a diode D124, a resistor R125, a resistor R126, a flyback control circuit 127, and/or a feedback resistor R128. The flyback transformer 122 may comprise a primary winding and a secondary winding. The primary winding may be coupled in series with the FET Q123. Although illustrated as the FET Q123, any switching transistor or other suitable semiconductor switch may be coupled in series with the primary winding of the flyback transformer 122. The secondary winding of the flyback transformer 122 may be coupled to the bus capacitor C_{BUS} via the diode D124. A bus voltage feedback signal V_{BUS-FB} may be generated, e.g., by a voltage divider comprising the resistors R125, R126 coupled across the bus capacitor C_{BUS}. The flyback control circuit 127 may receive the bus voltage feedback signal V_{BUS-FB} and/or a control signal representative of the current through the FET Q123 from the feedback resistor R128, which may be coupled in series with the FET Q123. The flyback control circuit 127 may control the FET Q123 to selectively conduct current through the flyback transformer 122 to generate the bus voltage V_{BUS}. The flyback control circuit 127 may render the FET Q123 conductive and non-conductive, for example, to control the magnitude of the bus voltage V_{BUS} towards a target bus voltage V_{BUS-TRGT} in response to the DC magnitude of the bus voltage feedback signal V_{BUS-FB} and/or the magnitude of the current through the FET Q123.

The controllable lighting device 100 may comprise one or more load regulation circuits, such as LED drive circuits 130, 140, for controlling power delivered to (e.g., the intensities of) the LED light sources 102, 104, respectively. The LED drive circuits 130, 140 may each receive the bus voltage V_{BUS} and may adjust magnitudes of respective load currents I_{LOAD1}, I_{LOAD2} conducted through the LED light sources 102, 104 and/or magnitudes of respective load voltages V_{LOAD1}, V_{LOAD2} generated across the LED light sources. Examples of various embodiments of LED drive circuits are described in U.S. Pat. No. 8,492,987, filed Jul. 23, 2013, and U.S. Pat. No. 9,253,829, issued Feb. 2, 2016, both entitled LOAD CONTROL DEVICE FOR A LIGHT-EMITTING DIODE LIGHT SOURCE, the entire disclosures of which are hereby incorporated by reference.

The controllable lighting device 100 may comprise a control circuit 150 for controlling the LED drive circuits 130, 140 to control the magnitudes of the respective load currents I_{LOAD1}, I_{LOAD2} conducted through the LED light sources 102, 104 to adjust the respective intensities of the LED light sources. For example, the control circuit 150 may comprise a digital control circuit, such as, a microprocessor, a microcontroller, a programmable logic device (PLD), an application specific integrated circuit (ASIC), a field-programmable gate array (FPGA), or any other suitable processing device or controller. The control circuit 150 may be configured to turn one or both of the LED light sources 102, 104 on to turn the controllable lighting device 100 on, and turn both of the LED light sources 102, 104 off to turn the controllable lighting device 100 off. The control circuit 150 may be configured to control the respective intensities of the LED light sources 102, 104 to control the intensity and/or the color (e.g., the color temperature) of the cumulative light emitted by the controllable lighting device 100. The control circuit 150 may be configured to adjust (e.g., dim) a present intensity L_{PRES} of the cumulative light emitted by the controllable lighting device 100 towards a target intensity L_{TRGT}, which may range across a dimming range of the controllable light source, e.g., between a low-end intensity L_{LE} (e.g., a minimum intensity, such as approximately 0.1%-1.0%) and a high-end intensity L_{HE} (e.g., a maximum intensity, such as approximately 100%). The control circuit 150 may be configured to adjust a present color temperature T_{PRES} of the cumulative light emitted by the controllable lighting device 100 towards a target color temperature T_{TRGT}, which may range between a cool-white color temperature (e.g., approximately 3100-4500 K) and a warm-white color temperature (e.g., approximately 2000-3000 K). For example, the control circuit may be configured to determine a respective target intensity L_{TRGT1}, L_{TRGT2} for each of the LED light sources 102, 104 in response to the target intensity L_{TRGT} and/or the target color temperature T_{TRGT} for the controllable lighting device 100.

The control circuit 150 may comprise a memory (not shown) configured to store operational characteristics of the controllable lighting device 100 (e.g., the target intensity L_{TRGT}, the target color temperature T_{TRGT}, the low-end intensity L_{LE}, the high-end intensity L_{HE}, etc.). The memory may be implemented as an external integrated circuit (IC) or as an internal circuit of the control circuit 150. The controllable lighting device 100 may comprise a power supply 160 that may be coupled to a winding 162 of the flyback transformer 122 of the power converter circuit 120 and may be configured to generate a supply voltage V_{CC} for powering the control circuit 150 and other low-voltage circuitry of the controllable lighting device.

The controllable lighting device 100 may comprise a communication circuit 170 coupled to the control circuit 150. The communication circuit 170 may comprise a wireless communication circuit, such as, for example, a radio-frequency (RF) transceiver coupled to an antenna 172 for transmitting and/or receiving RF signals. The wireless communication circuit may be an RF transmitter for transmitting RF signals, an RF receiver for receiving RF signals, or an infrared (IR) transmitter and/or receiver for transmitting and/or receiving IR signals. The communication circuit 170 may be coupled to the hot connection H and the neutral connection N of the controllable lighting device 100 for transmitting a control signal via the electrical wiring using, for example, a power-line carrier (PLC) communication technique. The control circuit 150 may be configured to determine the target intensity L_{TRGT} and/or the target color temperature T_{TRGT} for the controllable lighting device 100 in response to messages (e.g., digital messages) received via the communication circuit 170.

The LED drive circuits 130, 140 may comprise respective controllably conductive devices (e.g., switching devices such as field-effect transistors (FET) Q132, Q142) coupled (e.g., in series) with the LED light sources 102, 104, respectively, for conducting the load currents I_{LOAD1}, I_{LOAD2}. Each FET Q132, Q142 may comprise any type of suitable power semiconductor switch, such as, for example, a bipolar junction transistor (BJT), and/or an insulated-gate bipolar transistor (IGBT). The control circuit 150 may be configured to generate one or more drive signals such as drive signals V_{DR1}, V_{DR2} that may be received by gates of the respective FETs Q132, Q142 for rendering the FETs conductive and non-conductive. The control circuit 150 may be configured to pulse-width modulate (PWM) the drive signals V_{DR1}, V_{DR2} to adjust average magnitudes of the load currents I_{LOAD1}, I_{LOAD2}, respectively. For example, the control circuit 150 may be configured to adjust respective duty cycles of the drive signals V_{DR1}, V_{DR2} to adjust the average magnitudes of the load currents I_{LOAD1}, I_{LOAD2}, respectively. The control circuit 150 may be configured to determine an on-time T_{ON} for a present cycle of each of the drive signals V_{DR1}, V_{DR2} based on the target intensities L_{TRGT1}, L_{TRGT2} of the LED light sources 102, 104, respectively (e.g., as will be described in greater detail below).

The FETs Q132, Q142 may be coupled (e.g., in series) with respective feedback circuits, e.g., current feedback (CFB) circuits 134, 144. The current feedback circuits 134, 144 may generate respective current feedback signals V_{FB1}, V_{FB2}, which may be received by the control circuit 150. The control circuit 150 may generate feedback window control signals V_{WIN1}, V_{WIN2} that may be received by the respective current feedback circuits 134, 144 for controlling the operation of the current feedback circuits, such that the magnitudes of the current feedback signals V_{FB1}, V_{FB2} may indicate peak magnitudes I_{PK1}, I_{PK2} of the respective load currents I_{LOAD1}, I_{LOAD2}. The control circuit 150 may be configured to sample the current feedback signals V_{FB1}, V_{FB2} during a present cycle of each of the drive signals V_{DR1}, V_{DR2} and determine a respective operating period T_{OP} for the present cycle of each of the drive signals V_{DR1}, V_{DR2} in response to the respective peak magnitudes I_{PK1}, I_{PK2} of the load currents I_{LOAD1}, I_{LOAD2} (e.g., as will be described in greater detail below).

The peak magnitudes I_{PK1}, I_{PK2} of the respective load currents I_{LOAD1}, I_{LOAD2} may be dependent upon the magnitude of the bus voltage V_{BUS}. The control circuit 150 may be configured to control the operation of the power converter circuit 120 in response to the peak magnitudes I_{PK1}, I_{PK2} of the respective load currents I_{LOAD1}, I_{LOAD2}. The control circuit 150 may generate a bus control signal V_{BUS-CNTL} that may be received by the flyback control circuit 127 for adjusting the target bus voltage V_{BUS-TRGT} of the power converter circuit 120. The control circuit 150 may be configured to limit the respective operating periods T_{OP} of the drive signals V_{DR1}, V_{DR2} to be between a minimum operating period T_{OP-MIN} and a maximum operating period T_{OP-MAX}. For example, the control circuit 150 may be configured to increase the magnitude of the bus voltage V_{BUS} when the operating period T_{OP} of at least one of the drive signals V_{DR1}, V_{DR2} is less than the minimum operating period T_{OP-MIN}. The control circuit 150 may be configured to decrease the magnitude of the bus voltage V_{BUS} when the operating period T_{OP} of at least one of the drive signals V_{DR1}, V_{DR2} is greater than the maximum operating period T_{OP-MAX}.

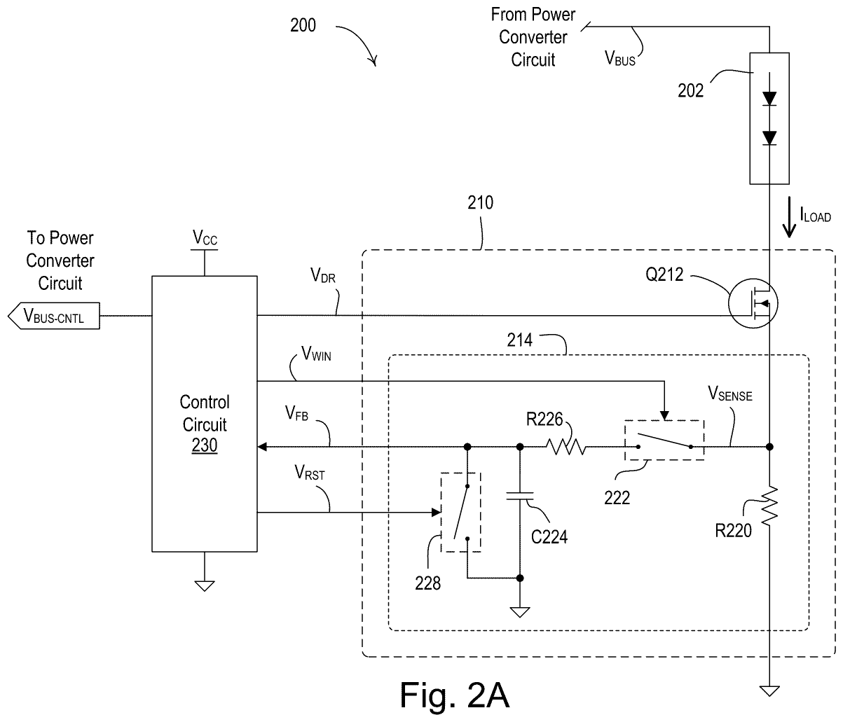

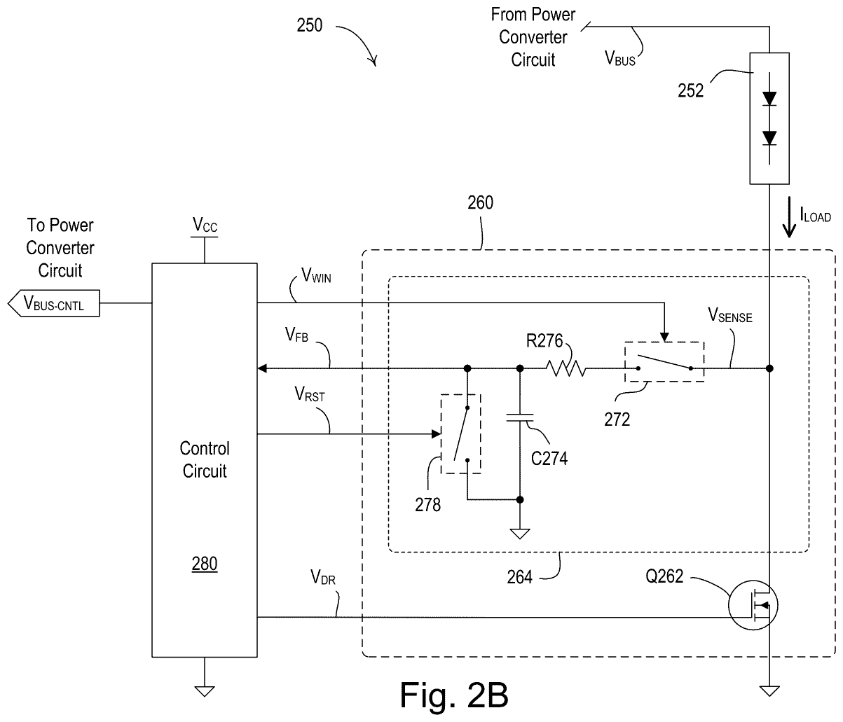

FIG. 2A is a simplified schematic diagram of an example of an LED drive circuit 210 (e.g., one of the LED drive circuits 130, 140) of an electrical device 200, such as a load control device, an LED driver or a controllable light source (e.g., the controllable lighting device 100). The LED drive circuit 210 may be coupled in series with an LED light source 202 (e.g., one of the LED light sources 102, 104) for conducting a load current I_{LOAD} through the LED light source. The LED light source 202 may be configured to receive a bus voltage V_{BUS} from a power converter circuit (e.g., the power converter circuit 120).

The electrical device 200 may comprise a control circuit 230 (e.g., the control circuit 150). The control circuit 230 may also generate a drive signal V_{DR} for controlling the LED drive circuit 210 to adjust a magnitude (e.g., an average magnitude) of the load current I_{LOAD} through the LED light source. The control circuit 230 may be configured to adjust the intensity of the LED light source 202 towards a target intensity L_{TRGT} that may range between a minimum intensity L_{MIN} (e.g., approximately 0.1%-1.0%) and a maximum intensity L_{MAX} (e.g., approximately 100%). The minimum intensity L_{MIN} may be approximately the lowest intensity at which the control circuit 230 may control the LED light source 202 under steady state conditions (e.g., when the target intensity L_{TRGT} is being held constant). The control circuit 230 may be configured to determine a target current I_{TRGT} (e.g., a target average current to which to regulate the average magnitude of the load current I_{LOAD}) from the target intensity L_{TRGT}. The control circuit 230 may be configured to fade (e.g., gradually adjust over a period of time) the target intensity L_{TRGT} (and thus the present intensity) of the LED light source 202. The control circuit 230 may be configured to fade the LED light source 202 from off to on by turning on the LED light source to a minimum fading intensity L_{FADE-MIN} and then slowly increasing the present intensity L_{PRES} of the LED light source from the minimum fading intensity L_{FADE-MIN} to the target intensity L_{TRGT}. For example, the minimum fading intensity L_{FADE-MIN} may be less than the minimum intensity L_{MIN} (e.g., such as approximately 0.02%).

The LED drive circuit 210 may comprise a controllably conductive device (e.g., a switching device, such as a FET Q212) coupled in series with the LED light source 202. The FET Q212 may comprise any type of suitable power semiconductor switch, such as, for example, a bipolar junction transistor (BJT), and/or an insulated-gate bipolar transistor (IGBT). The drive signal V_{DR} generated by the control circuit 230 may be received by a gate of the FET Q212. The FET Q212 may be rendered conductive and non-conductive for adjusting the average magnitude of the load current I_{LOAD}. The control circuit 230 may be configured to control the FET Q212 as a switching device by driving the FET Q212 into the saturation region when the FET Q212 is conductive. The FET Q212 may be characterized by a drain-source on resistance R_{DS-ON} when the FET Q212 is controlled into the saturation region. The control circuit 230 may be configured to control the LED drive circuit 210 on a periodic (e.g., a cyclic) basis. For example, the control circuit 230 may be configured to pulse-width modulate (PWM) the drive signal V_{DR} to pulse-width modulate the load current I_{LOAD}. Each cycle of control of the LED driver circuit 210 may be associated with (e.g., characterized by) an operating period T_{OP} (e.g., a length of the cycle).

The LED drive circuit 210 may comprise a current feedback circuit 214 coupled in series with the FET Q212 for generating a current feedback signal V_{FB} that may have a DC magnitude representative of a magnitude (e.g., a peak magnitude I_{PK}) of the load current I_{LOAD}. As shown in FIG. 2A, the current feedback circuit 214 may be coupled to the source of the FET Q212. The current feedback circuit 214 may comprise a sense resistor R220 that may have a resistance R_{SENSE}. The sense resistor R220 may be coupled in series between the FET Q212 and circuit common for generating a sense voltage V_{SENSE} across the sense resistor R220. The current feedback circuit 214 may comprise a first controllable switch 222 that receives the sense voltage V_{SENSE}. The first controllable switch 222 may be rendered conductive and non-conductive in response to a feedback window control signal V_{WIN} (e.g., a switch control signal) generated by the control circuit 230. The first controllable switch 222 may be coupled to a filter circuit, which may comprise a capacitor C224 and a resistor R226. The feedback signal V_{FB} may be generated across the capacitor C224. The current feedback circuit 214 may also comprise a second controllable switch 228 coupled in parallel with the capacitor C224. The second controllable switch 228 may be rendered conductive and non-conductive in response to a reset control signal VRST generated by the control circuit 230.

The control circuit 230 may be configured to control the first controllable switch 222 of the current feedback circuit 214 to be conductive during the on-time T_{ON} of the drive signal V_{DR} (e.g., when the FET Q212 is conductive). After the first controllable switch 222 is rendered conductive at the beginning of the on-time T_{ON}, the capacitor C224 may charge to approximately the peak magnitude V_{PK} of the sense voltage V_{SENSE} through the resistor R226, such that the magnitude of the current feedback signal V_{FB} may indicate the peak magnitude I_{PK} of the load current I_{LOAD}. The control circuit 230 may receive the current feedback signal V_{FB} generated by the current feedback circuit 214, and may sample the current feedback signal V_{FB} during the on-time T_{ON} (e.g., for the entirety of the on-time T_{ON} or during a portion of the on-time T_{ON}) of the drive signal V_{DR} to determine the peak magnitude I_{PK} of the load current I_{LOAD}. For example, the control circuit 230 may calculate the peak magnitude I_{PK} of the load current I_{LOAD} using the sampled magnitude of the current feedback signal V_{FB} and the resistance R_{SENSE} of the sense resistor R220, e.g., I_{PK}=V_{FB}/R_{SENSE}. For example, the control circuit 230 may store the resistance R_{SENSE} of the sense resistor R220 in memory and may retrieve the resistance R_{SENSE} from memory in order to calculate the peak magnitude I_{PK} of the load current I_{LOAD}. The control circuit 230 may render the first controllable switch 222 non-conductive at or before the end of the on-time T_{ON}. After the end of the on-time T_{ON}, the control circuit 230 may render the second controllable switch 228 conductive for a reset period T_{RST} (e.g., a reset pulse) in order to discharge the capacitor C224 so that the current feedback circuit 214 may control the magnitude of the current feedback signal V_{FB} to indicate the peak magnitude I_{PK} of the load current I_{LOAD} during a subsequent cycle (e.g., the next cycle) of the LED drive circuit 210.

During each cycle of control of the LED drive circuit 210, the control circuit 230 may be configured to render the FET Q212 conductive for a first portion (e.g., an on-time T_{ON}) of the cycle and non-conductive for a second portion (e.g., an off-time T_{OFF}) of the cycle. For example, the control circuit 230 may be configured to adjust the average magnitude of the load current I_{LOAD} by adjusting a duty cycle DC of the drive signal V_{DR}, e.g., DC=T_{ON}/T_{OP}=T_{ON}/(T_{ON}+T_{OFF}). The control circuit 230 may be configured to determine the on-time T_{ON} for the drive signal V_{DR} (e.g., for a present cycle of the LED drive circuit 210) based on the target intensity L_{TRGT} of the LED light source 202 (e.g., using open loop control). Since the FET Q212 is controlled as a switching device and is rendered conductive (e.g., controlled into the saturation region) during the on-time T_{ON} of the drive signal V_{DR}, the load current I_{LOAD} may be characterized by an on-time that is the same length as the on-time T_{ON} of the drive signal V_{DR}. The FET Q212 may conduct the load current I_{LOAD} at the peak magnitude I_{PK} during the on-time. The control circuit 230 may be configured to determine a length of the operating period T_{OP} of the drive signal V_{DR} for the present cycle of the LED drive circuit 210 in response to the peak magnitude I_{PK} of the load current I_{LOAD} as determined from the current feedback signal V_{FB} (e.g., using closed loop control). The control circuit 230 may not control the peak magnitude I_{PK} of the load current I_{LOAD} during the on-time using closed loop control (e.g., to regulate the peak magnitude I_{PK} towards a target peak current by comparing the peak current I_{PK} to a threshold).

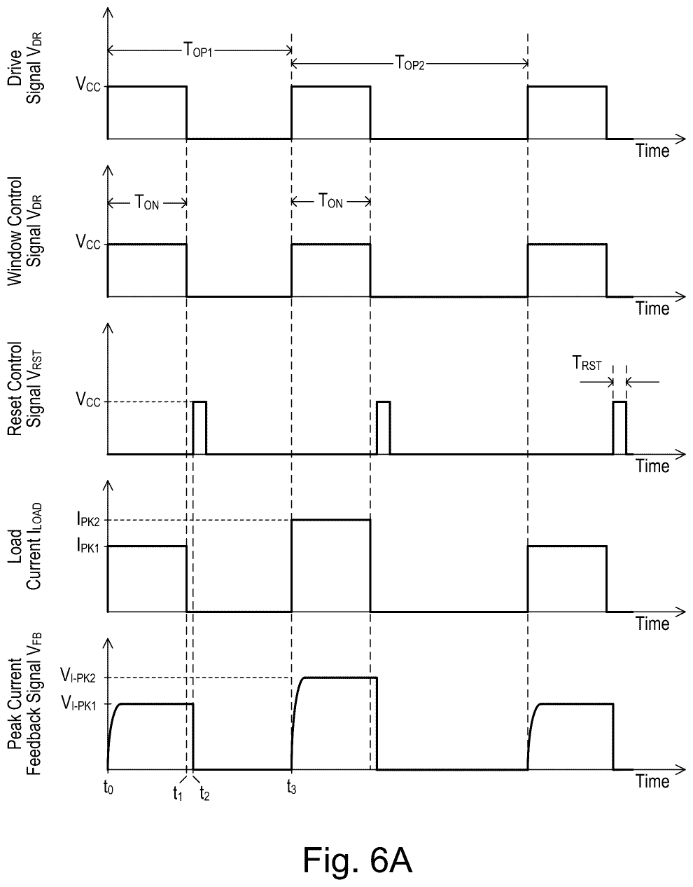

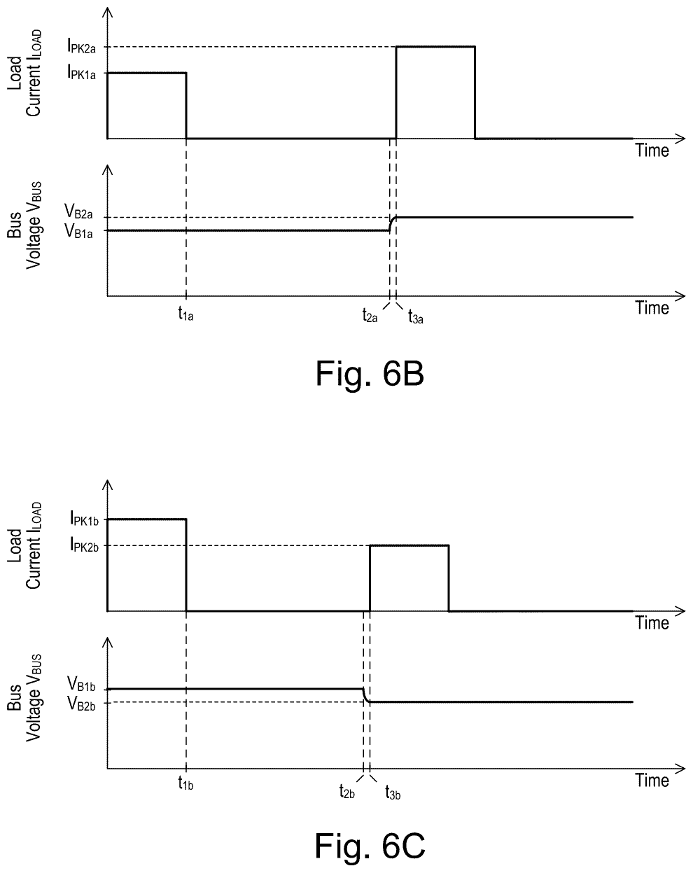

The control circuit 230 may also be configured to generate a bus control signal V_{BUS-CNTL} that may be received by the power converter circuit for adjusting the magnitude of the bus voltage V_{BUS}. The control circuit 230 may be configured to maintain the bus control signal V_{BUS-CNTL} constant (e.g., substantially constant) during each cycle of the LED drive circuit 210. The control circuit 230 may be configured to control the bus control signal V_{BUS-CNTL} to adjust the magnitude from one cycle to the next (e.g., as will be described in greater detail below with reference to FIGS. 6B and 6C). Since the FET Q212 is driven into the saturation region during the on-time T_{ON}, the peak magnitude I_{PK} of the load current I_{LOAD} during the on-time T_{ON} may be dependent upon the magnitude of the bus voltage V_{BUS}, the drain-source on resistance R_{DS-ON}, the resistance R_{SENSE} of the sense resistor R220, and the characteristics of the LED light source 202 (e.g., the equivalent resistance of the LED light source). Since the control circuit 230 is not able to adjust the drain-source on resistance R_{DS-ON}, the resistance R_{SENSE} of the sense resistor R220, and the characteristics of the LED light source 202, and the magnitude of the bus voltage V_{BUS} remains constant during each cycle of the LED driver circuit 210, the control circuit 230 may not be able to control the peak magnitude I_{PK} of the load current I_{LOAD} during the present cycle. The peak magnitude I_{PK} of the load current I_{LOAD} may be different for different LED light sources that may be controlled by the LED drive circuit 210 (e.g., the peak magnitude I_{PK} may not be deterministic). Accordingly, the peak magnitude I_{PK} of the load current I_{LOAD} may be considered an uncontrolled or unregulated magnitude (e.g., an uncontrolled or unregulated current). Since the control circuit 230 does not control the peak magnitude I_{PK} of the load current I_{LOAD} during the on-time using closed loop control (e.g., to regulate the peak magnitude I_{PK} towards a target peak current), the peak magnitude I_{PK} of the load current I_{LOAD} may not be dependent upon the operation of the control circuit 230 during the present cycle (e.g., during the on-time). If the control circuit 230 used closed loop control to control the peak magnitude I_{PK} during the on-time, the peak magnitude I_{PK} would be the same (e.g., controlled to the target peak current) independent of the particular LED light source controlled by the LED drive circuit 210.

The control circuit 230 may be configured to control the average magnitude of the load current I_{LOAD} by adjusting the operating period T_{OP} for the present cycle of the drive signal V_{DR}. The control circuit may be configured to determine the operating period T_{OP} for the present cycle of the drive signal V_{DR} in response to the peak magnitude I_{PK} of the load current I_{LOAD} (e.g., an uncontrolled current) as determined from the current feedback signal V_{FB}. For example, the control circuit 230 may be configured to calculate the operating period T_{OP} required to achieve the target current I_{TRGT} (e.g., the average magnitude of the load current I_{LOAD}) at the present on-time T_{ON} and the present peak magnitude I_{PK} of the load current I_{LOAD} (e.g., as determined from the current feedback signal V_{FB}), e.g., T_{OP}=(I_{PK}·T_{ON})/I_{TRGT}. The off-time T_{OFF} of the drive signal may be dependent upon the determined operating period T_{OP}, e.g., T_{OFF}=T_{OP}−T_{ON}. The control circuit may render the FET conductive at the end of the operating period T_{OP} (e.g., the end of the present off-time T_{OFF}) to start the next cycle.

FIG. 2B is a simplified schematic diagram of another example of an LED drive circuit 260 (e.g., one of the LED drive circuits 130, 140) of an electrical device 250, such as a load control device, an LED driver or a controllable light source (e.g., the controllable lighting device 100). The LED drive circuit 260 may be coupled in series with an LED light source 252 (e.g., one of the LED light sources 102, 104) for conducting a load current I_{LOAD} through the LED light source. The LED light source 252 may be configured to receive a bus voltage V_{BUS} from a power converter circuit (e.g., the power converter circuit 120).

The electrical device 250 may comprise a control circuit 280 (e.g., the control circuit 150). The control circuit 280 may also generate a drive signal V_{DR} for controlling the LED drive circuit 260 to adjust a magnitude (e.g., an average magnitude) of the load current I_{LOAD} through the LED light source. The control circuit 280 may be configured to adjust the intensity of the LED light source 252 towards a target intensity L_{TRGT} that may range between a minimum intensity L_{MIN} (e.g., approximately 0.1%-1.0%) and a maximum intensity L_{MAX} (e.g., approximately 100%). The minimum intensity L_{MIN} may be approximately the lowest intensity at which the control circuit 280 may control the LED light source 252 under steady state conditions (e.g., when the target intensity L_{TRGT} is being held constant). The control circuit 280 may be configured to determine a target current I_{TRGT} (e.g., a target average current to which to regulate the average magnitude of the load current I_{LOAD}) from the target intensity L_{TRGT}. The control circuit 280 may be configured to fade (e.g., gradually adjust over a period of time) the target intensity L_{TRGT} (and thus the present intensity) of the LED light source 252. The control circuit 280 may be configured to fade the LED light source 252 from off to on by turning on the LED light source to a minimum fading intensity L_{FADE-MIN} and then slowly increasing the present intensity L_{PRES} of the LED light source from the minimum fading intensity L_{FADE-MIN} to the target intensity L_{TRGT}. For example, the minimum fading intensity L_{FADE-MIN} may be less than the minimum intensity L_{MIN} (e.g., such as approximately 0.02%).

The LED drive circuit 260 may comprise a controllably conductive device (e.g., a switching device, such as a FET Q262) coupled in series with the LED light source 252. As shown in FIG. 2B, the drain of the FET Q262 may be coupled to the bus voltage V_{BUS}, and the source of the FET Q262 may be coupled to circuit common. The FET Q262 may comprise any type of suitable power semiconductor switch, such as, for example, a bipolar junction transistor (BJT), and/or an insulated-gate bipolar transistor (IGBT). The drive signal V_{DR} generated by the control circuit 280 may be received by a gate of the FET Q262. The FET Q262 may be rendered conductive and non-conductive for adjusting the average magnitude of the load current I_{LOAD}. The control circuit 280 may be configured to control the FET Q262 as a switching device by driving the FET Q262 into the saturation region when the FET Q262 is conductive. The FET Q262 may be characterized by a drain-source on resistance R_{DS-ON} when the FET Q262 is controlled into the saturation region. The control circuit 280 may be configured to control the LED drive circuit 260 on a periodic (e.g., a cyclic) basis. For example, the control circuit 280 may be configured to pulse-width modulate (PWM) the drive signal V_{DR} to pulse-width modulate the load current I_{LOAD}. Each cycle of control of the LED driver circuit 260 may be associated with (e.g., characterized by) an operating period T_{OP} (e.g., a length of the cycle).

The LED drive circuit 260 may comprise a current feedback circuit 264 that may be configured to generate a current feedback signal V_{FB} that may have a DC magnitude representative of a magnitude (e.g., a peak magnitude I_{PK}) of the load current I_{LOAD}. The current feedback circuit 264 may be coupled to the drain of the FET Q262 and may be responsive to a sense voltage V_{SENSE} developed across the FET Q262 (e.g., the current feedback circuit 264 may not comprise a sense resistor, such as the sense resistor R220 shown in FIG. 2A). The magnitude of the sense voltage V_{SENSE} may be dependent upon the peak magnitude I_{PK} of the load current I_{LOAD} and the drain-source on resistance R_{DS-ON} of the FET Q262. The current feedback circuit 264 may comprise a first controllable switch 272 that receives the sense voltage V_{SENSE}. The first controllable switch 272 may be rendered conductive and non-conductive in response to a feedback window control signal V_{WIN} (e.g., a switch control signal) generated by the control circuit 280. The first controllable switch 272 may be coupled to a filter circuit, which may comprise a capacitor C274 and a resistor R276. The feedback signal V_{FB} may be generated across the capacitor C274. The current feedback circuit 264 may also comprise a second controllable switch 278 coupled in parallel with the capacitor C274. The second controllable switch 278 may be rendered conductive and non-conductive in response to a reset control signal VRST generated by the control circuit 280.

The control circuit 280 may be configured to control the first controllable switch 272 of the current feedback circuit 264 to be conductive during the on-time T_{ON} of the drive signal V_{DR} (e.g., when the FET Q262 is conductive). After the first controllable switch 272 is rendered conductive at the beginning of the on-time T_{ON}, the capacitor C274 may charge to approximately the peak magnitude V_{PK} of the sense voltage V_{SENSE} through the resistor R276, such that the magnitude of the current feedback signal V_{FB} may indicate the peak magnitude I_{PK} of the load current I_{LOAD}. The control circuit 280 may receive the current feedback signal V_{FB} generated by the current feedback circuit 264, and may sample the current feedback signal V_{FB} during the on-time T_{ON} (e.g., for the entirety of the on-time T_{ON} or during a portion of the on-time T_{ON}) of the drive signal V_{DR} to determine the peak magnitude I_{PK} of the load current I_{LOAD}.

The control circuit 280 may calculate the peak magnitude I_{PK} of the load current I_{LOAD} using the sampled magnitude of the current feedback signal V_{FB} and the drain-source on resistance R_{DS-ON} of the FET Q262, e.g., I_{PK}=V_{FB}/R_{DS-ON}. For example, the control circuit 280 may store the drain-source on resistance R_{DS-ON} of the FET Q262 in memory and may retrieve the drain-source on resistance R_{DS-ON} from memory in order to calculate the peak magnitude I_{PK} of the load current I_{LOAD} (e.g., the drain-source on resistance R_{DS-ON} may be a fixed or constant value). In addition, the drain-source on resistance R_{DS-ON} may be dependent upon a present temperature T_{PRES} of the FET Q212. For example, the control circuit 280 may be configured to determine the present temperature T_{PRES} of the FET Q212 using a temperature measuring circuit and/or a temperature sensing device located near the FET Q212. The control circuit 280 may also be configured to estimate the present temperature T_{PRES} of the FET Q212 based on one or more operating parameters of the electrical device 250, such as the peak magnitude I_{PK} of the load current I_{LOAD} and/or the sense voltage V_{SENSE} developed across the FET Q262. The control circuit 280 may be configured to determine the drain-source on resistance R_{DS-ON} of the FET Q262 based on the determined present temperature T_{PRES} of the FET Q212 using a predetermined relationship between the drain-source on resistance R_{DS-ON} and the present temperature T_{PRES} of the FET Q212. For example, the predetermined relationship between the drain-source on resistance R_{DS-ON} and the present temperature T_{PRES} of the FET Q212 may be stored in memory as a lookup table and/or a function (e.g., equation). The control circuit 280 may calculate the peak magnitude I_{PK} of the load current I_{LOAD} using the determined drain-source on resistance R_{DS-ON} of the FET Q262. For example, the predetermined relationship between the drain-source on resistance R_{DS-ON} and the present temperature T_{PRES} and/or an initial value of the drain-source on resistance R_{DS-ON} may be calibrated during a manufacturing procedure of the electrical device 250.

The control circuit 280 may render the first controllable switch 272 non-conductive at or before the end of the on-time T_{ON}. After the end of the on-time T_{ON}, the control circuit 280 may render the second controllable switch 278 conductive for a reset period T_{RST} (e.g., a reset pulse) in order to discharge the capacitor C274 so that the current feedback circuit 264 may control the magnitude of the current feedback signal V_{FB} to indicate the peak magnitude I_{PK} of the load current I_{LOAD} during a subsequent cycle (e.g., the next cycle) of the LED drive circuit 260.

During each cycle of control of the LED drive circuit 260, the control circuit 280 may be configured to render the FET Q262 conductive for a first portion (e.g., an on-time T_{ON}) of the cycle and non-conductive for a second portion (e.g., an off-time T_{OFF}) of the cycle. For example, the control circuit 250 may be configured to adjust the average magnitude of the load current I_{LOAD} by adjusting a duty cycle DC of the drive signal V_{DR}, e.g., DC=T_{ON}/T_{OP}=T_{ON}/(T_{ON}+T_{OFF}). The control circuit 280 may be configured to determine the on-time T_{ON} for the drive signal V_{DR} (e.g., for a present cycle of the LED drive circuit 260) based on the target intensity L_{TRGT} of the LED light source 252 (e.g., using open loop control). Since the FET Q212 is controlled as a switching device and is rendered conductive (e.g., controlled into the saturation region) during the on-time T_{ON} of the drive signal V_{DR}, the load current I_{LOAD} may be characterized by an on-time that is the same length as the on-time T_{ON} of the drive signal V_{DR}. The FET Q262 may conduct the load current I_{LOAD} at the peak magnitude I_{PK} during the on-time. The control circuit 280 may be configured to determine a length of the operating period T_{OP} of the drive signal V_{DR} for the present cycle of the LED drive circuit 260 in response to the peak magnitude I_{PK} of the load current I_{LOAD} as determined from the current feedback signal V_{FB} (e.g., using closed loop control). The control circuit 280 may not control the peak magnitude I_{PK} of the load current I_{LOAD} during the on-time using closed loop control (e.g., to regulate the peak magnitude I_{PK} towards a target peak current by comparing the peak current I_{PK} to a threshold).

The control circuit 280 may also be configured to generate a bus control signal V_{BUS-CNTL} that may be received by the power converter circuit for adjusting the magnitude of the bus voltage V_{BUS}. The control circuit 280 may be configured to maintain the bus control signal V_{BUS-CNTL} constant (e.g., substantially constant) during each cycle of the LED drive circuit 260. The control circuit 280 may be configured to control the bus control signal V_{BUS-CNTL} to adjust the magnitude from one cycle to the next (e.g., as will be described in greater detail below with reference to FIGS. 6B and 6C). Since the FET Q262 is driven into the saturation region during the on-time T_{ON}, the peak magnitude I_{PK} of the load current I_{LOAD} during the on-time T_{ON} may be dependent upon the magnitude of the bus voltage V_{BUS}, the drain-source on resistance R_{DS-ON}, and the characteristics of the LED light source 252 (e.g., the equivalent resistance of the LED light source). Since the control circuit 280 is not able to adjust the drain-source on resistance R_{DS-ON} and the characteristics of the LED light source 252, and the magnitude of the bus voltage V_{BUS} remains constant during each cycle of the LED driver circuit 260, the control circuit 280 may not be able to control the peak magnitude I_{PK} of the load current I_{LOAD} during the present cycle. The peak magnitude I_{PK} of the load current I_{LOAD} may be different for different LED light sources that may be controlled by the LED drive circuit 260 (e.g., the peak magnitude I_{PK} may not be deterministic). Accordingly, the peak magnitude I_{PK} of the load current I_{LOAD} may be considered an uncontrolled or unregulated magnitude (e.g., an uncontrolled or unregulated current). Since the control circuit 280 does not control the peak magnitude I_{PK} of the load current I_{LOAD} during the on-time using closed loop control (e.g., to regulate the peak magnitude I_{PK} towards a target peak current), the peak magnitude I_{PK} of the load current I_{LOAD} may not be dependent upon the operation of the control circuit 280 during the present cycle (e.g., during the on-time). If the control circuit 280 used closed loop control to control the peak magnitude I_{PK} during the on-time, the peak magnitude I_{PK} would be the same (e.g., controlled to the target peak current) independent of the particular LED light source controlled by the LED drive circuit 260.

The control circuit 280 may be configured to control the average magnitude of the load current I_{LOAD} by adjusting the operating period T_{OP} for the present cycle of the drive signal V_{DR}. The control circuit may be configured to determine the operating period T_{OP} for the present cycle of the drive signal V_{DR} in response to the peak magnitude I_{PK} of the load current I_{LOAD} (e.g., an uncontrolled magnitude) as determined from the current feedback signal V_{FB}. For example, the control circuit 280 may be configured to calculate the operating period T_{OP} required to achieve the target current I_{TRGT} (e.g., the average magnitude of the load current I_{LOAD}) at the present on-time T_{ON} and the present peak magnitude I_{PK} of the load current I_{LOAD} (e.g., as determined from the current feedback signal V_{FB}), e.g., T_{OP}=(I_{PK}·T_{ON})/I_{TRGT}. The off-time T_{OFF} of the drive signal may be dependent upon the determined operating period T_{OP}, e.g., T_{OFF}=T_{OP}−T_{ON}. The control circuit may render the FET conductive at the end of the operating period T_{OP} (e.g., the end of the present off-time T_{OFF}) to start the next cycle.

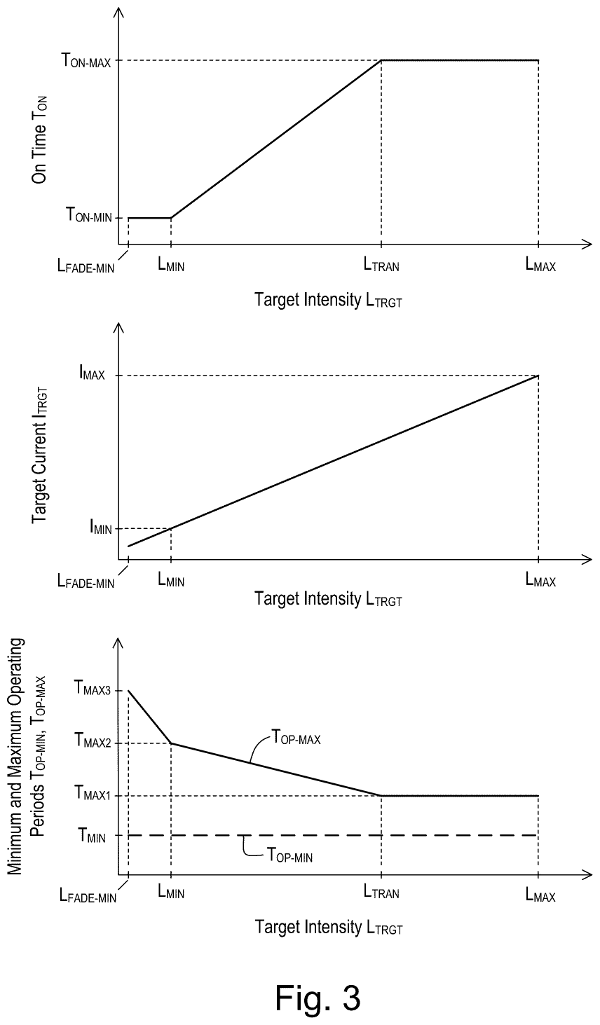

FIG. 3 shows plots illustrating controls relationships that may be utilized by a control circuit (e.g., the control circuits 150, 230, 280) to control an LED drive circuit (e.g., the LED drive circuits 13, 140 of FIG. 1, the LED drive circuit 210 of FIG. 2A, and/or the LED drive circuit 260 of FIG. 2B). FIG. 3 shows a plot of an example relationship between an on-time T_{ON} of the drive signal V_{DR} and a target intensity L_{TRGT} of the LED drive circuit. When the target intensity L_{TRGT} is greater than (e.g., greater than or equal to) a transition intensity L_{TRAN} (e.g., between the transition intensity L_{TRAN} and the maximum intensity L_{MAX}), the on-time T_{ON} may be set to a maximum on-time T_{ON-MAX}. When the target intensity L_{TRGT} is less than (e.g., less than or equal to) the minimum intensity L_{MIN} (e.g., between the minimum intensity L_{MIN} and the minimum fading intensity L_{FADE-MIN}), the on-time T_{ON} may be set to a minimum on-time T_{ON-MIN}. When the target intensity L_{TRGT} is between the minimum intensity L_{MIN} and the transition intensity L_{TRAN}, the on-time T_{ON} may be adjusted (e.g., linearly adjusted between the minimum on-time T_{ON-MIN} and the maximum on-time T_{ON-MAX}) with respect to the target intensity L_{TRGT} (e.g., as shown in FIG. 3).

The control circuit may be configured to determine a target current I_{TRGT} (e.g., a target average magnitude of the load current I_{LOAD}) for the LED light source in response to the target intensity L_{TRGT}. FIG. 3 also shows a plot of an example relationship between the target current I_{TRGT} and the target intensity L_{TRGT} of the LED drive circuit. As shown in FIG. 3, the target current I_{TRGT} may be linearly dependent upon the target intensity L_{TRGT} and may range between a minimum current IMIN (e.g., at the minimum intensity L_{MIN}) and a maximum current IMAX (e.g., at the maximum intensity L_{MAX}). In addition, the relationship between the target current I_{TRGT} and the target intensity L_{TRGT} may be a non-linear relationship.

The control circuit may be configured to control the average magnitude of the load current I_{LOAD} by adjusting the operating period T_{OP} for the present cycle of the drive signal V_{DR}. The control circuit may be configured to determine the operating period T_{OP} for the present cycle of the drive signal V_{DR} in response to the peak magnitude I_{PK} of the load current I_{LOAD} (e.g., an uncontrolled magnitude) as determined from the current feedback signal V_{FB}. For example, the control circuit may be configured to calculate the operating period T_{OP} required to achieve the target current I_{TRGT} (e.g., average current) at the present on-time T_{ON} and the present peak magnitude I_{PK} of the load current I_{LOAD} (e.g., as determined from the current feedback signal V_{FB}), e.g., T_{OP}=(I_{PK}·T_{ON})/I_{TRGT}. The off-time T_{OFF} of the drive signal may be dependent upon the determined operating period T_{OP}, e.g., T_{OFF}=T_{OP}−T_{ON}. The control circuit may render the FET conductive at the end of the operating period T_{OP} (e.g., the end of the present off-time T_{OFF}) to start the next cycle.

The control circuit may be configured to control the bus control signal V_{BUS-CNTL} to adjust the bus voltage V_{BUS} to attempt to maintain the operating period T_{OP} between a minimum operating period T_{OP-MIN} and a maximum operating period T_{OP-MAX}. When the operating period T_{OP} (e.g., as determined by the control circuit in dependence upon the peak magnitude I_{PK} of the load current I_{LOAD}) is less than the minimum operating period T_{OP-MIN}, the control circuit may be configured to increase the magnitude of the bus voltage V_{BUS}. Increasing the peak magnitude I_{PK} of the load current I_{LOAD} may cause the control circuit to increase the operating period T_{OP} (e.g., such that the operating period T_{OP} may be greater than the minimum operating period T_{OP-MIN}). When the operating period T_{OP} is greater than the maximum operating period T_{OP-MAX}, the control circuit may be configured to decrease the magnitude of the bus voltage V_{BUS} (e.g., to decrease the peak magnitude I_{PK} of the load current I_{LOAD}). Decreasing the peak magnitude I_{PK} of the load current I_{LOAD} may cause the control circuit to decrease the operating period T_{OP} (e.g., such that the operating period T_{OP} may be less than the maximum operating period T_{OP-MAX}).

The minimum operating period T_{OP-MIN} and the maximum operating period T_{OP-MAX} may be constant values and/or variable values that are dependent upon the target intensity L_{TRGT}. FIG. 3 also shows a plot of an example relationship between the minimum and maximum operating periods T_{OP-MIN}, T_{OP-MAX} and the target intensity L_{TRGT}. The minimum operating period T_{OP-MIN} may be a minimum value T_{MIN} (e.g., a constant value such as 10 microseconds, which may be independent of the target intensity L_{TRGT}). When the target intensity L_{TRGT} is greater than (e.g., greater than or equal to) the transition intensity L_{TRAN} (e.g., between the transition intensity L_{TRAN} and the maximum intensity L_{MAX}), the maximum operating period T_{OP-MAX} may be set to a first maximum value T_{MAX1} (e.g., a constant value independent of the target intensity L_{TRGT}). When the target intensity L_{TRGT} is between the minimum intensity L_{MIN} and the transition intensity L_{TRAN}, the maximum operating period T_{OP-MAX} may be a variable value that is dependent upon the target intensity L_{TRGT}. For example, the maximum operating period T_{OP-MAX} may be adjusted between the first maximum value T_{MAX1} and a second maximum value T_{MAX2}, and may be linearly related to the target intensity L_{TRGT} when the target intensity L_{TRGT} is between the minimum intensity L_{MIN} and the transition intensity L_{TRAN}. As shown in FIG. 3, the maximum operating period T_{OP-MAX} may increase from the first maximum value T_{MAX1} to the second maximum value T_{MAX2} as the target intensity L_{TRGT} decreases from the transition intensity L_{TRAN} to the minimum intensity L_{MIN}. When the target intensity L_{TRGT} is less than (e.g., less than or equal to) the minimum intensity L_{MIN} (e.g., between the minimum intensity L_{MIN} and the minimum fading intensity L_{FADE-MIN}), the maximum operating period T_{OP-MAX} may be a variable value that is dependent upon the target intensity L_{TRGT}. For example, the maximum operating period T_{OP-MAX} may be adjusted between the second maximum value T_{MAX2} and a third maximum value T_{MAX3}, and may be linearly related to the target intensity L_{TRGT} when the target intensity L_{TRGT} is less than the minimum intensity L_{MIN}. As shown in FIG. 3, the maximum operating period T_{OP-MIN} may increase from the second maximum value T_{MAX2} to the third maximum value T_{MAX3} as the target intensity L_{TRGT} decreases from the minimum intensity L_{MIN} to the minimum fading intensity L_{FADE-MIN}. The values for T_{MAX1}, T_{MAX2}, and T_{MAX3} may vary in accordance with the target intensity L_{TRGT}. For instance, T_{MAX3} may have a value of 800 microseconds in some scenarios.

When the target intensity L_{TRGT} is greater than the transition intensity L_{TRAN}, the on-time T_{ON} of the drive signal V_{DR} may be set to a constant value (e.g., the maximum on-time T_{ON-MAX} as shown in FIG. 3). In addition, when the target intensity L_{TRGT} is greater than the transition intensity L_{TRAN} (e.g., near the maximum intensity L_{MAX}), the operating period T_{OP} of the drive signal V_{DR} may be controlled to approximately the minimum value T_{MIN} (e.g., a constant value as shown in FIG. 3). As the target intensity L_{TRGT} is adjusted near the maximum intensity L_{MAX} (e.g., above the transition intensity L_{TRAN}), the control circuit may adjust the magnitude of the bus voltage V_{BUS} (e.g., and thus the peak magnitude I_{PK} of the load current I_{LOAD}) to attempt to maintain the operating period T_{OP} of the drive signal V_{DR} greater than the minimum operating period T_{OP-MIN} (e.g., the minimum value T_{MIN}). As a result, the operating period T_{OP} of the drive signal V_{DR} may be approximately constant (e.g., approximately equal to the minimum value T_{MIN}) with respect to the target intensity L_{TRGT} when the target intensity L_{TRGT} is greater than the transition intensity L_{TRAN} and near the maximum intensity L_{MAX}. In addition, the peak magnitude I_{PK} of the load current I_{LOAD} may be monotonically related (e.g., approximately linearly related) to the target current I_{TRGT} when the target intensity L_{TRGT} is greater than the transition intensity L_{TRAN}. For example, as the target intensity L_{TRGT} decreases from the maximum intensity L_{MAX} towards the transition intensity L_{TRAN}, the peak magnitude I_{PK} of the load current I_{LOAD} may also decrease, and vice versa. As the target intensity L_{TRGT} continues to decrease towards the transition intensity L_{TRAN}, the operating period T_{OP} may increase above the minimum operating period T_{OP-MIN} (e.g., the minimum value T_{MIN}), but still be limited below the maximum operating period T_{OP-MAX} (e.g., the first maximum value T_{MAX1}).

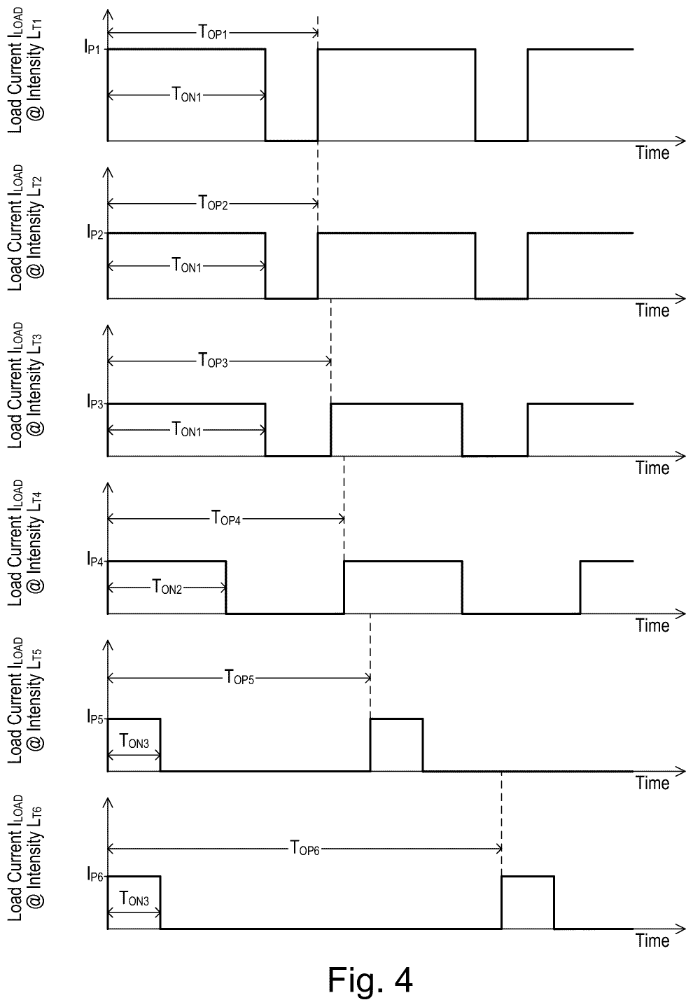

FIG. 4 shows example waveforms of a load current I_{LOAD} illustrating the operation of a controllable lighting device (e.g., the lighting control devices 100 and/or the electrical devices 200, 250) at various target intensities L_{T1}-L_{T6}. When the target intensity L_{TRGT} is at a first target intensity L_{T1} (e.g., at or near the maximum intensity L_{MAX}), a control circuit (e.g., the control circuits 150, 230, 280) may set the on-time T_{ON} of the drive signal V_{DR} to a first on-time T_{ON1} (e.g., the maximum on-time T_{ON-MAX} as shown in FIG. 3), which may result in the load current having an on-time of the same length as the first on-time T_{ON1}. The load current I_{LOAD} may be characterized by a first peak magnitude I_{P1} during the first on-time T_{ON1}. The control circuit may control the operating period T_{OP} of the drive signal V_{DR} such that the load current I_{LOAD} has a first operating period T_{OP1} (e.g., in dependence upon the first peak magnitude I_{P1} of the load current I_{LOAD} during the first on-time T_{ON1} as described above). For example, the first operating period T_{OP1} may be the minimum operating period T_{OP-MIN} (e.g., the minimum value T_{MIN}).

When the target intensity L_{TRGT} is decreased to a second target intensity L_{T2} (e.g., that is less than the first target intensity L_{T1} and greater than the transition intensity L_{TRAN}), the load current I_{LOAD} may still have the first on-time T_{ON1} (e.g., the maximum on-time T_{ON-MAX} as shown in FIG. 3). The load current I_{LOAD} may be characterized by a second peak magnitude I_{P2} during the first on-time T_{ON1} at the second target intensity L_{T2}. The load current I_{LOAD} may have a second operating period T_{OP2} at the second target intensity L_{T2}. Since the operating period T_{OP} of the drive signal V_{DR} may be approximately constant when the target intensity L_{TRGT} is greater than the transition intensity L_{TRAN}, the second operating period T_{OP2} of the load current I_{LOAD} at the second target intensity L_{T2} may be approximately the same as the first operating period T_{OP1} of the load current I_{LOAD} at the first target intensity L_{T1}. For example, the second operating period T_{OP2} may be the minimum operating period T_{OP-MIN} (e.g., the minimum value T_{MIN}). In addition, since the peak magnitude I_{PK} of the load current I_{LOAD} may be monotonically related (e.g., approximately linearly related) to the target current I_{TRGT} when the target intensity L_{TRGT} is greater than the transition intensity L_{TRAN}, the peak magnitude I_{PK} of the load current I_{LOAD} may decrease from the first peak magnitude I_{P1} to the second peak magnitude I_{P2} in response to the target intensity L_{TRGT} decreasing from the first target intensity L_{T1} to the second target intensity L_{T2}.

When the target intensity L_{TRGT} is decreased to a third target intensity L_{T3} (e.g., approximately equal to the transition intensity L_{TRAN}), the load current I_{LOAD} may still have the first on-time T_{ON1} (e.g., the maximum on-time T_{ON-MAX} as shown in FIG. 3). The peak magnitude I_{PK} of the load current I_{LOAD} may decrease to a third peak magnitude I_{P3} during the first on-time T_{ON1} when at the third target intensity L_{T3}. The load current I_{LOAD} may have a third operating period T_{OP3} at the third target intensity L_{T3}, which may be greater than the first operating period T_{OP1} at the first target intensity L_{T1} and/or the second operating period T_{OP2} at the second target intensity L_{T2} (e.g., may be between the minimum value T_{MIN} and the maximum value T_{MAX}).

When the target intensity L_{TRGT} is decreased to a fourth target intensity L_{T4} (e.g., less than the transition intensity L_{TRAN} and greater than the minimum intensity L_{MIN}), the load current I_{LOAD} may have a second on-time T_{ON2}, which may be less than the first on-time T_{ON1} (e.g., linearly dependent upon the target intensity L_{TRGT} as shown in FIG. 3). The load current I_{LOAD} may be characterized by a fourth peak magnitude I_{P4} (e.g., which may be approximately equal to the third peak magnitude I_{PK3}). Since the maximum operating period T_{OP-MAX} increases from the first maximum value T_{MAX1} towards the second maximum value T_{MAX2} as the target intensity L_{TRGT} decreases below the transition intensity L_{TRAN} (e.g., as shown in FIG. 3), the load current I_{LOAD} may have a fourth operating period T_{OP4}, which may be greater than the third operating period T_{OP3}.

When the target intensity L_{TRGT} is decreased to a fifth target intensity L_{T5} (e.g., approximately equal to the minimum intensity L_{MIN}), the load current I_{LOAD} may be set to a third on-time T_{ON3} (e.g., the minimum on-time T_{ON-MIN} as shown in FIG. 3). The load current I_{LOAD} may be characterized by a fifth peak magnitude I_{P5} (e.g., which may be approximately equal to the third peak magnitude I_{PK3} and/or the fourth peak magnitude I_{P4}). The load current I_{LOAD} may have a fifth operating period Tops, which may be greater than the fourth operating period T_{OP4}.

When the target intensity L_{TRGT} is decreased to a sixth target intensity L_{T6} (e.g., less than the minimum intensity L_{MIN} and greater than the minimum fading intensity L_{FADE-MIN}), the load current I_{LOAD} may be still set to the third on-time T_{ON3} (e.g., the minimum on-time T_{ON-MIN} as shown in FIG. 3). The load current I_{LOAD} may be characterized by a sixth peak magnitude I_{P6} (e.g., which may be approximately equal to the third peak magnitude I_{PK3}, the fourth peak magnitude I_{P4}, and/or the fifth peak magnitude I_{P5}). The load current I_{LOAD} may have a sixth operating period T_{OP6}, which may be greater than the fifth operating period T_{OP5}.

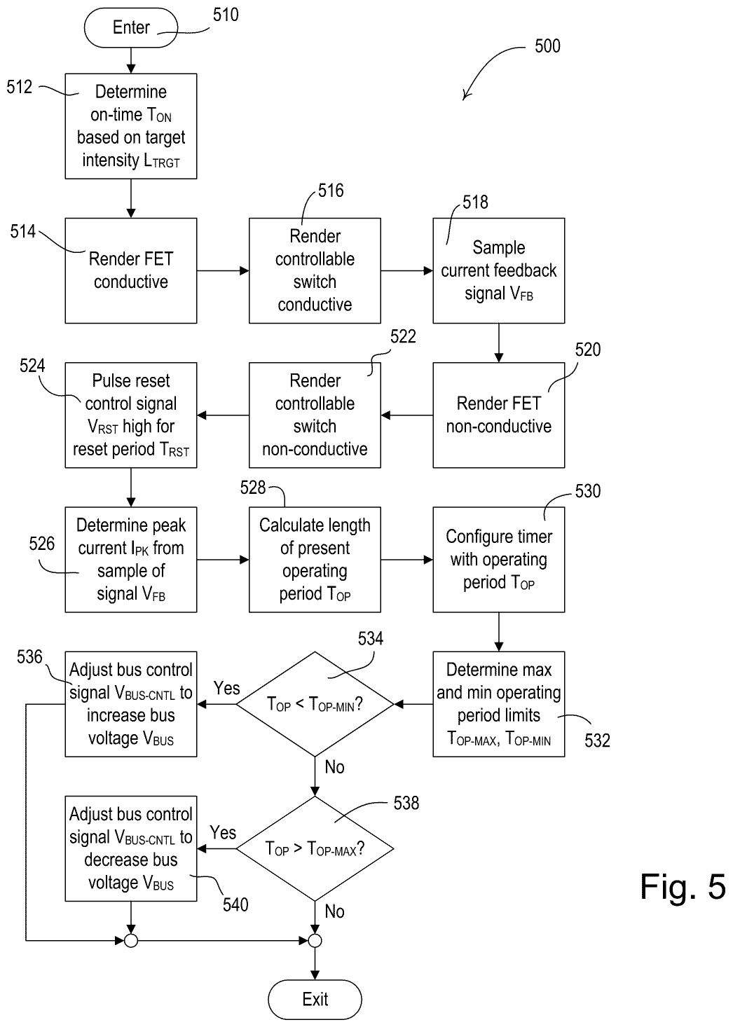

FIG. 5 is a simplified flow diagram of an example control procedure 500 that may be executed by a control circuit (e.g., the control circuits 150, 230, 280) of a controllable lighting device (e.g., the lighting control device 100 and/or the electrical devices 200, 250) for controlling an LED light source (e.g., the LED light sources 102, 104, 202, 252). FIGS. 6A-6C show example waveforms illustrating the operation of the controllable lighting device while the control circuit is executing the control procedure 500. The control circuit may generate a drive signal V_{DR} for rendering a FET (e.g., the FETs Q132, Q142, Q212) of an LED drive circuit (e.g., the LED drive circuits 130, 140, 210, 260) conductive and non-conductive during each cycle of control of the LED drive circuit. The control circuit may receive a current feedback signal V_{FB} from a current feedback circuit (e.g., the current feedback circuits 134, 144, 214, 264), where the magnitude of the current feedback signal V_{FB} may indicate a magnitude (e.g., a peak magnitude) of a load current I_{LOAD} conducted through the LED light source. The control circuit may control the LED drive circuit to control an intensity of the LED light source towards a target intensity L_{TRGT}. The waveforms of FIGS. 6A-6C illustrate the operation of the controllable lighting device when the target intensity L_{TRGT} is constant.

The control procedure 500 may be executed by the control circuit at step 510, for example, at the beginning of each cycle of control of the LED drive circuit (e.g., periodically). For example, the period of execution of the control procedure 500 may be set during a previous (e.g., preceding) execution of the control procedure 500. At 512, the control circuit may determine an on-time T_{ON} of the drive signal V_{DR} based on the target intensity L_{TRGT} (e.g., as shown in FIG. 3). The on-time T_{ON} may be determined based on predetermined and/or stored values or may be calculated by the control circuit based on the target intensity L_{TRGT}. At 514, the control circuit may render the FET of the LED drive circuit conductive at the beginning of the present cycle of control of the LED drive circuit. For example, the control circuit may render the FET conductive at 514 by driving the drive signal V_{DR} high towards the supply voltage V_{CC} (e.g., as shown at to in FIG. 6A). After the FET is rendered conductive, the LED light source may conduct the load current I_{LOAD} through the FET and the load current I_{LOAD} may have a peak magnitude I_{PK} during the on-time T_{ON} (e.g., a first peak magnitude I_{PK1} as shown in FIG. 6A).

At 516, the control circuit may also render a first controllable switch (e.g., the controllable switches 222, 272) of the current feedback circuit conductive at the beginning of the present cycle or slightly after the beginning of the present cycle to cause the magnitude of the current feedback signal V_{FB} to indicate the peak magnitude I_{PK} (e.g., the first peak magnitude I_{PK1}) of the load current I_{LOAD} during the present cycle. For example, the control circuit may drive a window control signal V_{WIN} high towards the supply voltage V_{CC} (e.g., as shown at to in FIG. 6A) to render the first controllable switch conductive at 516. After the first controllable switch is rendered conductive, a capacitor of the current feedback circuit (e.g., the capacitors C224, C274) may charge and the magnitude of the current feedback signal V_{FB} may increase to a first feedback level V_{I-PK1}, which may indicate the first peak magnitude I_{PK1} of the load current I_{LOAD}.

At 518, the control circuit may sample the current feedback signal V_{FB} for later use in determining the peak magnitude I_{PK} of the load current I_{LOAD} (e.g., the first peak magnitude I_{PK1}). For example, the control circuit may sample the current feedback signal V_{FB} near the end of the on-time T_{ON} (e.g., before time t₁ as shown in FIG. 6A). At 520, the control circuit may drive the drive signal V_{DR} low towards circuit common to render the FET non-conductive, such that the FET stops conducting the load current I_{LOAD} (e.g., as shown at time t₁ in FIG. 6A). At 522, the control circuit may drive the window control signal V_{WIN} low towards circuit common to render the first controllable switch of the current feedback circuit non-conductive (e.g., as shown at time t₁ in FIG. 6A). At 524, the control circuit may be configured to render a second controllable switch (e.g., the controllable switches 228, 278) conductive to discharge the capacitor of the current feedback circuit. For example, the control circuit may drive a reset control signal VRST high towards the supply voltage V_{CC} for a reset period T_{RST} (e.g., to generate a reset pulse) to render the second controllable switch conductive for the length of the reset period T_{RST} (e.g., as shown at time t₂ of FIG. 6A).

At 526, the control circuit may be configured to determine the peak magnitude I_{PK} (e.g., the first peak magnitude I_{PK1}) of the load current I_{LOAD} based on the sampled magnitude of the current feedback signal V_{FB} (e.g., as determined at 518). For example, the control circuit may calculate the peak magnitude I_{PK} of the load current I_{LOAD} using the sampled magnitude of the current feedback signal V_{FB} and a resistance of a sense resistor (e.g., the resistance R_{SENSE} of the sense resistor R220 of the LED drive circuit 210 shown in FIG. 2A), which may be stored in memory. In addition, the control circuit may calculate the peak magnitude I_{PK} of the load current I_{LOAD} using the sampled magnitude of the current feedback signal V_{FB} and a drain-source on resistance of a FET of an LED drive circuit (e.g., the drain-source on resistance R_{DS-ON} of the FET Q262 of the LED drive circuit 260 shown in FIG. 2B). For example, the control circuit may retrieve the drain-source on resistance (e.g., a constant or fixed value) from memory. In addition, the control circuit may determine the drain-source on resistance based on a present temperature T_{PRES} of the FET. For example, the control circuit may be configured to determine the present temperature T_{PRES} of the FET using a temperature measuring circuit and/or a temperature sensing device, and/or may be configured to estimate the temperature of the FET Q262 based on one or more operating parameters of the electrical device.

At 528, the control circuit may be configured to calculate an operating period T_{OP} (e.g., a first operating period T_{OP1} as shown in FIG. 6A) for the present cycle of the drive signal V_{DR}. For example, the control circuit may be configured to calculate the operating period T_{OP} as a function of the target current I_{TRGT}, the on-time T_{ON} (e.g., as determined at 512), and/or the present peak magnitude I_{PK} of the load current I_{LOAD} (e.g., the first peak magnitude I_{PK1} as determined at 526), e.g., T_{OP}=(I_{PK}·T_{ON})/I_{TRGT}. For example, the control circuit may determine the target current I_{TRGT} at 528 based on the target intensity L_{TRGT} (e.g., as shown in FIG. 3). At 530, the control circuit may configure a timer with the operating period T_{OP} (e.g., the first operating period T_{OP1}) to cause the control circuit to begin the next cycle of the LED drive circuit at the end of the operating period T_{OP}. For example, the timer may begin running at the beginning of the present cycle (e.g., at time to of FIG. 6A and/or before the length of the present cycle has been determined), and the control circuit may execute the control procedure 500 again to start the next cycle when the timer indicates the end of the operating period T_{OP}. During a subsequent execution of the control procedure 500 (e.g., at the beginning of the next cycle), the control circuit may render the FET conductive at 514 and the load current I_{LOAD} may have a second peak magnitude I_{PK2} during the on-time T_{ON} (e.g., as shown in FIG. 6A). In addition, the control circuit may render the first controllable switch of the current feedback circuit conductive at 516 and the magnitude of the current feedback signal V_{FB} may increase to a second feedback level V_{I-PK2}, which may indicate the second peak magnitude I_{PK2} of the load current I_{LOAD}. At 526, the control circuit may calculate the operating period T_{OP} (e.g., a second operating period T_{OP2}) for the next cycle as a function of the target current I_{TRGT}, the on-time T_{ON}, and/or the present peak magnitude I_{PK} of the load current I_{LOAD} (e.g., a second peak magnitude I_{PK2}).

The control circuit may control a power converter circuit (e.g., the power converter circuit 102) to adjust the magnitude of the bus voltage to attempt to maintain the operating period T_{OP} between a minimum operating period T_{OP-MIN} and a maximum operating period T_{OP-MAX}. At 532, the control circuit may determine the minimum operating period T_{OP-MIN} and the maximum operating period T_{OP-MAX} based on the target intensity L_{TRGT} (e.g., as shown in FIG. 3). When the operating period T_{OP} (e.g., as calculated at 526) is less than the minimum operating period T_{OP-MIN} at 534, the control circuit may increase the magnitude of the bus voltage V_{BUS} at 536, before the control procedure 500 exits. The control circuit may increase the magnitude of the bus voltage V_{BUS} by a fixed amount (e.g., a predetermined amount) and/or by a relative amount (e.g., by a percentage of the present bus voltage V_{BUS}). For example, after the end of the on-time T_{ON} (e.g., as shown at time t₁ₐ of FIG. 6B), the control circuit may determine to increase the magnitude of the bus voltage V_{BUS} from a first bus magnitude V_{B1a} to a second bus magnitude V_{B2a}. For example, the second bus magnitude V_{B2a} may be proportional to the first bus magnitude V_{B1a}, e.g., V_{B2a}=V_{B1a}/K, where K is a constant that is less than one. The control circuit may adjust the bus voltage control signal V_{BUS-CTRL} to set the target bus voltage V_{BUS-TRGT} of the power converter circuit to the second bus magnitude V_{B2a} (e.g., towards the end of the operating period T_{OP} as shown at time t₂ₐ in FIG. 6B). Since the magnitude of the bus voltage V_{BUS} is equal to the second bus magnitude V_{B2a} when the FET is rendered conductive at the beginning of the next cycle (e.g., at time t₃ₐ in FIG. 6B), the peak magnitude I_{PK} of the load current I_{LOAD} may increase from a first peak magnitude I_{PK1a} during the previous cycle to a second peak magnitude I_{PK2}a during the next cycle.

When the operating period T_{OP} is not less than the minimum operating period T_{OP-MIN} at 534, but is greater than the maximum operating period T_{OP-MAX} at 538, the control circuit may decrease the magnitude of the bus voltage V_{BUS} at 540, before the control procedure 500 exits. The control circuit may decrease the magnitude of the bus voltage V_{BUS} by a fixed amount (e.g., a predetermined amount) and/or by a relative amount (e.g., by a percentage of the present bus voltage V_{BUS}). For example, after the end of the on-time T_{ON} (e.g., as shown at time t_{1b} of FIG. 6C), the control circuit may determine to decrease the magnitude of the bus voltage V_{BUS} from a first bus magnitude V_{B1b} to a second bus magnitude V_{B2b}. For example, the second bus magnitude V_{B2b} may be proportional to the first bus magnitude V_{B1b}, e.g., V_{B2b}=K·V_{B1b}, where K is a constant that is less than one. The control circuit may adjust the bus voltage control signal V_{BUS-CTRL} to set the target bus voltage V_{BUS-TRGT} of the power converter circuit to the second bus magnitude V_{B2b} (e.g., towards the end of the operating period T_{OP} as shown at time t_{2b} in FIG. 6C). Since the magnitude of the bus voltage V_{BUS} is equal to the second bus magnitude V_{B2b} when the FET is rendered conductive at the beginning of the next cycle (e.g., at time t_{3b} in FIG. 6C), the peak magnitude I_{PK} of the load current I_{LOAD} may decrease from a first peak magnitude I_{PK1} during the previous cycle to a second peak magnitude I_{PK2} during the next cycle.

When the operating period T_{OP} is not less than the minimum operating period T_{OP-MIN} at 534, and is not greater than the maximum operating period T_{OP-MAX} at 538, the control procedure 500 exits without the control circuit adjusting the magnitude of the bus voltage V_{BUS}. After the control procedure 500 exits, the control circuit may execute the control procedure 500 again when the timer indicates the end of the operating period T_{OP} (e.g., as determined at 526 of the present cycle).

Although described with reference to a controllable light source and/or an LED driver, one or more embodiments described herein may be used with other load control devices. For example, one or more of the embodiments described herein may be performed by a variety of load control devices that are configured to control of a variety of electrical load types, such as, for example, a LED driver for driving an LED light source (e.g., an LED light engine); a screw-in luminaire including a dimmer circuit and an incandescent or halogen lamp; a screw-in luminaire including a ballast and a compact fluorescent lamp; a screw-in luminaire including an LED driver and an LED light source; a dimming circuit for controlling the intensity of an incandescent lamp, a halogen lamp, an electronic low-voltage lighting load, a magnetic low-voltage lighting load, or another type of lighting load; an electronic switch, controllable circuit breaker, or other switching device for turning electrical loads or appliances on and off; a plug-in load control device, controllable electrical receptacle, or controllable power strip for controlling one or more plug-in electrical loads (e.g., coffee pots, space heaters, other home appliances, and the like); a motor control unit for controlling a motor load (e.g., a ceiling fan or an exhaust fan); a drive unit for controlling a motorized window treatment or a projection screen; motorized interior or exterior shutters; a thermostat for a heating and/or cooling system; a temperature control device for controlling a heating, ventilation, and air conditioning (HVAC) system; an air conditioner; a compressor; an electric baseboard heater controller; a controllable damper; a humidity control unit; a dehumidifier; a water heater; a pool pump; a refrigerator; a freezer; a television or computer monitor; a power supply; an audio system or amplifier; a generator; an electric charger, such as an electric vehicle charger; and an alternative energy controller (e.g., a solar, wind, or thermal energy controller). A single control circuit may be coupled to and/or adapted to control multiple types of electrical loads in a load control system.

What is claimed is:

1. An electric load control device, comprising:
controller circuitry to:
determine a peak load current using a voltage feedback signal received from an electric load device;
determine a current operating period for a controllably conductive device coupled between an AC source and the electric load device based on the peak load current;
determine whether the current operating period falls outside a defined operating period range; and
responsive to the determination that the current operating period falls outside the defined operating period range, adjust the bus voltage provided to the electric load device.

2. The electric load control device of claim 1, wherein to adjust the bus voltage provided to the electric load device, the controller circuitry to further:
adjust the duty cycle of power converter circuitry disposed between the controllably conductive device and the AC source to adjust the bus voltage provided to the electric load device.

3. The electric load control device of claim 2 wherein, responsive to a determination that the current operating period of the controllably conductive device falls below a minimum operating period threshold, the controller circuitry to further:
increase the duty cycle of the power converter circuitry to cause an increase in the bus voltage supplied to the electric load device.

4. The electric load control device of claim 2 wherein, responsive to a determination that the current operating period of the controllably conductive device exceeds a maximum operating period threshold, the controller circuitry to further:
decrease the duty cycle of the power converter circuitry to cause a decrease in the bus voltage supplied to the electric load device.

5. An electric load control method, comprising:
determining by controller circuitry a peak load current through an operatively coupled electric load device using a voltage feedback signal received from the electric load device;
determining by the controller circuitry a current operating period for a controllably conductive device coupled between an AC source and the electric load device based on the peak load current;
determining by the controller circuitry whether the current operating period falls outside a defined operating period range; and
responsive to the determination that the current operating period falls outside the defined operating period range, adjusting by the controller circuitry the bus voltage provided to the electric load device.

6. The electric load control method of claim 5, wherein adjusting the bus voltage provided to the electric load device, further comprises:
adjusting by the controller circuitry the duty cycle of operatively coupled power converter circuitry disposed between the controllably conductive device and the AC source to adjust the bus voltage provided to the electric load device.

7. The electric load control method of claim 6 wherein adjusting the bus voltage provided to the electric load device, further comprises:
causing by the controller circuitry an increase in the duty cycle of the power converter circuitry sufficient to cause an increase in the bus voltage supplied to the electric load device responsive to the determination that the current operating period of the controllably conductive device falls below a minimum operating period threshold.

8. The electric load control method of claim 6 wherein adjusting the bus voltage provided to the electric load device, further comprises:
causing by the controller circuitry a decrease in the duty cycle of the power converter circuitry sufficient to cause a decrease in the bus voltage supplied to the electric load device responsive to a determination that the current operating period of the controllably conductive device exceeds a maximum operating period threshold.

9. A non-transitory, machine readable, storage device that includes instructions that, when executed by controller circuitry disposed in an electric load controller, cause the controller circuitry to:
determine a peak load current through an operatively coupled electric load device using a voltage feedback signal received from the electric load device;
determine a current operating period for a controllably conductive device coupled between an AC source and the electric load device based on the peak load current;
determine whether the current operating period falls outside a defined operating period range; and
responsive to the determination that the current operating period falls outside the defined operating period range, cause an adjustment to the bus voltage provided to the electric load device.

10. The non-transitory, machine readable, storage device of claim 9, wherein the instructions that cause the controller circuitry to cause the adjustment to the bus voltage provided to the electric load device, further cause the controller circuitry to:
adjusting by the controller circuitry the duty cycle of operatively coupled power converter circuitry disposed between the controllably conductive device and the AC source to adjust the bus voltage provided to the electric load device.

11. The non-transitory, machine readable, storage device of claim 10, wherein the instructions that cause the controller circuitry to cause the adjustment to the bus voltage provided to the electric load device, further cause the controller circuitry to:
cause an increase in the duty cycle of the power converter circuitry sufficient to cause an increase in the bus voltage supplied to the electric load device responsive to the determination that the current operating period of the controllably conductive device falls below a minimum operating period threshold.

12. The non-transitory, machine readable, storage device of claim 10, wherein the instructions that cause the controller circuitry to cause the adjustment to the bus voltage provided to the electric load device, further cause the controller circuitry to:
cause a decrease in the duty cycle of the power converter circuitry sufficient to cause a decrease in the bus voltage supplied to the electric load device responsive to a determination that the current operating period of the controllably conductive device exceeds a maximum operating period threshold.
